(19) United States
(12) Patent Application Publication
(10) Pub. No.: US 2003/0012655 A1
(43) Pub. Date: Jan. 16, 2003

(54) Turbine rotor blades assembly and method for assembling the same

(76) Inventors: Tomoyoshi Sasaki, Hiroshima-shi (JP); Kyoichi Ikeno, Hiroshima-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/230,262

(22) Filed: Aug. 29, 2002

Related U.S. Application Data
(63) Continuation of application No. PCT/JP02/05696, filed on Jun. 7, 2001.

(51) Int. Cl. F03B 3/12

(52) U.S. Cl. 416/219 R

(57) ABSTRACT

A turbine rotor blades assembly is provided which can be assembled easily and which can also maintain a securely fixed circumferential relationship between top portions of adjacent turbine rotor blades during operation. The present invention provides a turbine rotor blades assembly having a plurality of turbine rotor blades fixed to the outer circumference of a turbine rotor comprising: the turbine rotor blades fixedly inserted into the turbine rotor and each including a profile member extending radially outwardly from a central axis and a top plate formed integrally with the profile member at the outer end thereof, wherein said top plate provides an abutment interconnection relationship between adjacent turbine rotor blades, wherein said abutment engaging surfaces between adjacent turbine rotor blades are slantingly angled relative to a mean straight line extending from the center of the rotor to the center of the profile member.

### BACKGROUND OF THE INVENTION

1. Field of the Invention

This invention relates to a turbine rotor blades assembly and a method for assembling the same.

2. Description of the Prior Art

Heat energy of a working medium has been converted into mechanical energy via steam turbine systems in a heat power plant or a atomic power plant.

Such a steam turbine system comprises a turbine casing, a plurality of sets of stator blades disposed longitudinally along the axis of the casing, and at least one set of turbine rotor blades fixed to the outer circumference of a turbine rotor such that the set of turbine rotor blades are disposed alternately with respect to the plurality of sets of stator blades, wherein each of the turbine rotor blades is supported rotatably around a longitudinal axis so as to rotate relative to the stator blades.

Such a prior art system includes shrouds inserted into each one of a plurality of tenon portions formed at the top end portions of the turbine rotor blades and then fixedly attached to each of the turbine rotor blades by calking. This forms an interconnecting structure which enables each one of a plurality of turbine rotor blades to be fixedly attached to the outer circumference of a turbine rotor in an evenly spaced apart relationship. Such a interconnecting structure between top end portions of the turbine rotor blades not only prevents vibration of the turbine rotor blades, but also keeps a constant dimensional gap between the inner surface of the casing and the outer portion of the turbine rotor blades, thereby preventing leakage of hot steam gas through that gap.

One problem with such a prior art assembly, however, has been that the task of shrouds calking depends on the personal skill of the particular person doing the calking, which makes it difficult to maintain the consistency of the calking and reliability of strength.

In order to deal with this problem, a ISB(Integral Shroud Blade) system to interconnect turbine rotor blades to each other, has been developed especially for low profile short rotor blades.

FIGS. 7 to 11 illustrates a turbine rotor blades assembly according to the prior art ISB system. As shown in FIG. 7, a turbine rotor blade 120 includes a platform 200 having a blade root portion 180 fixedly inserted into a disk 160 of a rotor 170, a profile member 220 extending radially outwardly from the platform 200, a top plate 240 formed integrally with the profile member 220, a plurality of these top plates 240 connecting adjacent top portions of a plurality of profile members 220 such that a plurality of turbine rotor blades 120 are combined circumferentially.

As shown in FIG. 8, the plurality of turbine rotor blades 120 are provided around the rotor 170 adjacent to each other in a circumferential direction. As shown especially in FIG. 9, the top plate 240 includes end surfaces 260 providing a abutment relationship between two top plates 240, and these end surfaces 260 have a parallel relationship with respect to the straight line extending from the center of the rotor 170 to the center of the profile member 220.

This ISB system, like the shrouds calking system described above, reduces vibration and/or stress during operation, since a plurality of turbine rotor blades are fixedly interconnected due to the end surfaces 260 providing the abutment relationship between the top plates 240 of the turbine rotor blades, when the turbine rotor blades 120 are assembled by inserting the blade root portions 180 into the outer portion of the disk 160 of the rotor 170.

The drawbacks of the ISB system are due to the fact that the abutting end surfaces of the two top plates are generally parallel with respect to the straight line extending from the center of the rotor to the center of the profile member.

That is, for a turbine rotor blade having a higher profile than a certain height, the pitch dimension will become enlarged significantly along the circumference of the disk due to a centrifugal force and thermal expansion during operation of the rotary blades. Such an expansion of the pitch dimension of the disk will also cause enlargement of the pitch dimension between top portions of adjacent turbine rotor blades in a circumferential direction, so that a clearance will occur between two adjacent end surfaces 260. On the one hand, if such expansion is taken into account during designing of the turbine rotor blades so as to maintain their circumferentially fixed relationship, two adjacent turbine rotor blades will overlap each other during assembling of the turbine rotor blades assembly, as shown in FIGS. 10 and 11, which makes assembling difficult. On the other hand, if the turbine rotor blades are designed to permit easy assembling, there will occur a clearance between each two adjacent end surfaces during operation of the turbine rotor blades assembly, which will damage the securely fixed circumferential relationship between each two adjacent top portions of the turbine rotor blades.

Accordingly, one object of the present invention is to provide a turbine rotor blades assembly which can be assembled easily and also can maintain a securely fixed circumferential relationship between each two adjacent top portions of the turbine rotor blades during operation thereof.

Another object of the present invention is to provide a method for assembling a turbine rotor blades assembly which can maintain a securely fixed circumferential relationship between each two adjacent top portions of the turbine rotor blades during operation thereof.

### SUMMARY OF THE INVENTION

The present invention relates to a turbine rotor blades assembly having a plurality of turbine rotor blades fixedly inserted into the outer circumference of a turbine rotor. Each of the turbine rotor blades fixedly inserted into the turbine rotor includes a profile member extending radially outwardly from the central axis, and a top plate formed integrally with the profile member at the outer end thereof, wherein said top plate provides an abutment interconnection relationship between adjacent turbine rotor blades,

wherein said abutment engaging surfaces between adjacent turbine rotor blades being slantingly angled relative to the mean straight line extending from the center of the rotor to the center of the profile member.

In accordance with this aspect of the present invention, the turbine rotor blades are assembled onto the rotor by mounting each turbine rotor blade one by one onto the outer circumference of the rotor, while keeping the end surface of a top plate of a turbine rotor blade to be mounted abutted against the end surface of the top plate of the previously mounted turbine rotor blade.

In addition, even when the pitch dimension along the circumference of the disk becomes enlarged due to a centrifugal force and thermal expansion during operation, there is no possibility of an undesired clearance occurring between two adjacent end surfaces of the turbine rotor blades, so that abutment engaging top end surfaces of two adjacent turbine rotor blades are forced against each other, because of the fact that abutment engaging end surfaces of two adjacent turbine rotor blades are slantingly angled relative to the mean straight line extending from the center of the rotor to the center of the profile member, thereby maintaining a securely fixed circumferential relationship between two adjacent top portions of the turbine rotor blades, and reducing vibration and/or stress during operation.

Preferably, said slant angle is between 5° and 30°.

Preferably, said plurality of turbine rotor blades include a plurality of turbine rotor blades each having a top plate with circumferential length different from these of the other top plates.

The present invention also relates to a method for assembling the above mentioned turbine rotor blades assembly, comprising inserting root portions of turbine rotor blades into corresponding rotor disks one by one until all of the turbine rotor blades are fixedly attached upon corresponding rotor disks, comprising: inserting a spacer member between a platform of the turbine rotor blade to be attached and outer surface of the rotor at the side opposite from the previously fixed turbine rotor blade; biasing the turbine rotor blade to be attached during assembling thereof so as to provide abutment engagement between a top plate of the turbine rotor blade to be attached and a top plate of the turbine rotor blade previously fixed; repeating said inserting step and biasing step for each of the turbine rotor blades until all of the turbine rotor blades are installed.

### BRIEF DESCRIPTION OF THE DRAWINGS

FIG. 1 illustrates a cross-sectional view of a turbine rotor blades assembly in accordance with the present invention when the assembly is in an operating state.

FIG. 2 illustrates an enlarged detail view of the assembly, as taken within a circle II drawn in FIG. 1.

FIG. 3 illustrates a cross-sectional view of a turbine rotor blades assembly in accordance with the present invention when the assembly is in an assembling state.

FIG. 4 illustrates an enlarged detail view of the assembly, as taken within a circle IV drawn in FIG. 3.

FIG. 5 illustrates a schematic diagram showing clearance between two adjacent turbine rotor blades for giving a mathematical explanation of variance thereof

FIG. 6 illustrates a graphical diagram showing a dimension of clearance versus a slanted angle between two adjacent turbine rotor blades calculated from FIG. 5.

FIG. 7 illustrates an isometric view of a prior art turbine rotor blades assembly.

FIG. 8 illustrates a cross-sectional view of the prior art turbine rotor blades assembly when the assembly is in an operating state.

FIG. 9 illustrates an enlarged detail view of the assembly, as taken within a circle IX drawn in FIG. 8.

FIG. 10 illustrates a cross-sectional view of the prior art turbine rotor blades assembly when the assembly is in an assembling state.

FIG. 11 illustrates an enlarged detail view of the assembly, as taken within a circle XI drawn in FIG. 10.

### DETAILED DESCRIPTION OF THE PREFERRED EMBODIMENT

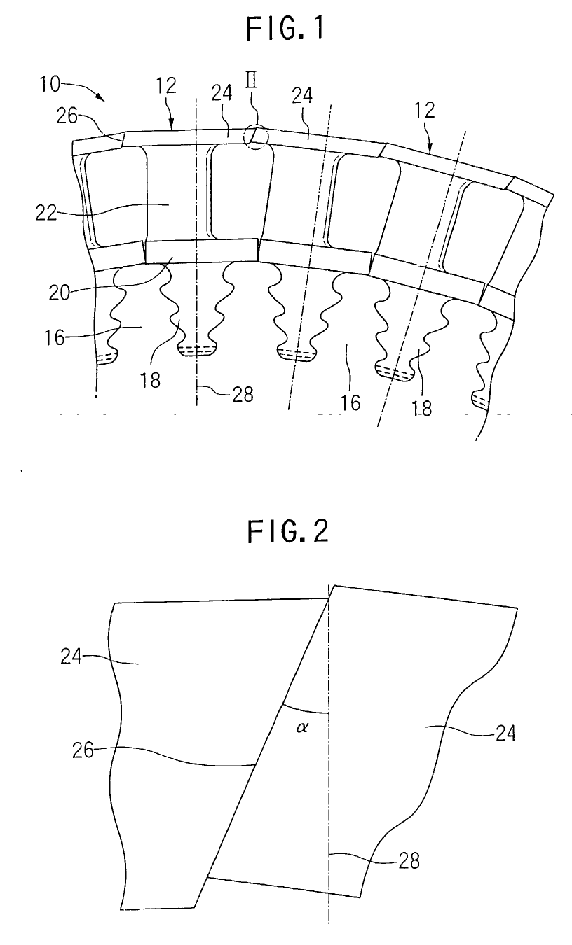

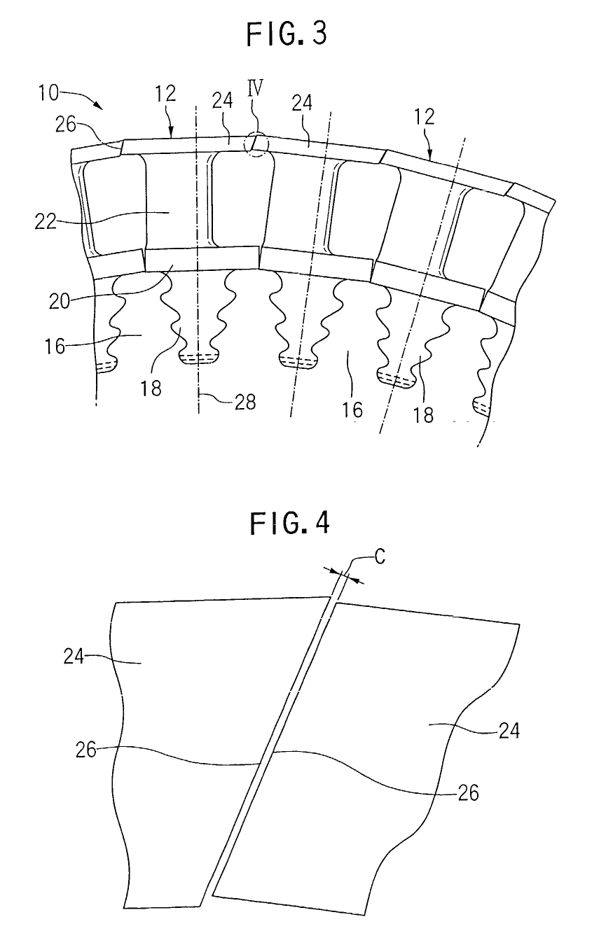

FIG. 1 illustrates a cross-sectional view of a turbine rotor blades assembly in accordance with the present invention when the assembly is in an operating state. FIG. 2 illustrates an enlarged detail view of the assembly, as taken within a circle II shown in FIG. 1. FIG. 3 illustrates a cross-sectional view of a turbine rotor blades assembly in accordance with the present invention when the assembly is in an assembling state. FIG. 4 illustrates an enlarged detail view of the assembly, as taken within a circle IV shown in FIG. 3.

Only the features of the turbine rotor blades assembly of the present invention will now be described in detail, that is, structures similar to those of the prior art turbine rotor blades system will not be explained.

Turbine rotor blades assembly 10 includes, as in the prior art, a plurality of turbine rotor blades 12 attached to the outer circumference of a rotor. The number of the turbine rotor blades 12 is a matter of design. Each turbine rotor blade 12 includes a platform 20 having a blade root 18 fixedly inserted into the outer portion of a rotor disk 16, a profile member 22 extending radially outwardly from the platform 20, and a top plate 24 formed integrally with the profile member. The plurality of turbine rotor blades 12 are interconnected with each other in such a way that the plurality of turbine rotor blades are combined in a circumferential direction via engagement between each pair of adjacent top plates 24. The platform 20, profile member 22, and top plate 24 may be formed integrally by shaving. Referring now to FIG. 2, abutment engaging surface 26 between adjacent turbine rotor blades 12 has a slanted angle a relative to a straight line extending from the center of the rotor to the center of the profile member 22, when turbine rotor blades 12 are attached around the rotor. Preferably, this slanted angle is in the range of 5° to 30°, although it may be selected properly depending upon the possible dimension of the clearance between two adjacent end surfaces 26 of the top plates 24 under a centrifugal force and thermal expansion during operation.

Each one of a plurality of turbine rotor blades may have a top plate having a circumferential length different from those of the other blades. Such a difference in circumferential length of each top plate may be selected so as to properly adjust the amount of outward relief of the top plates caused by a centrifugal force thereupon, thereby optimizing the abutment force between two adjacent end surfaces.

Having described the turbine rotor blades assembly 10 shown in FIGS. 1-2, its operation will now be described in detail below.

Referring now to FIGS. 3 and 4, the turbine rotor blades 12 are assembled to be attached around the rotor by mounting the turbine rotor blade one by one onto the outer circumference of the rotor, while keeping the end surface 26 of the top plate 24 of a turbine rotor blade to be mounted abutted against the adjacent end surface 26 of the top plate 24 of the previously mounted turbine rotor blade 12. Preferably, such a assembling process includes inserting a spacer member between the platform 20 of the turbine rotor blade 12 to be attached and an outer surface of the rotor at the side opposite from the previously fixed turbine rotor blade 12, and biasing the turbine rotor blade 12 to be attached during assembling thereof so as to provide abutment engagement between a top plate of the turbine rotor blade 12 to be attached and a top plate of the turbine rotor blade 12 previously fixed. Said inserting step and biasing step are repeated for each of the turbine rotor blades until the turbine rotor blades assembly 10 is completely constructed. Note that the spacer members are removed after all of the turbine rotor blades have been installed.

With reference again to FIGS. 1 and 2, even when the pitch dimension along the circumference of the disk 16 becomes enlarged due to a centrifugal force and thermal expansion acting upon the disk 16 during operation, there is no possibility of an undesired clearance C occurring between two adjacent end surfaces 26 of the turbine rotor blades 12, so that abutment engaging top end surfaces 26 of two adjacent turbine rotor blades 12 are forced against each other, because of the fact that abutment engaging end surfaces 26 of two adjacent top plates 24 being slantingly angled relative to the mean straight line 28 extending from the center of the rotor to the center of the profile member, thereby maintaining a securely fixed circumferential relationship between two adjacent top portions of the turbine rotor blades, and reducing vibration and/or stress during operation.

According to the embodiment described above, since a plurality of turbine rotor blades 12 are maintained in a securely fixed relationship with each other in the circumferential direction thereof, vibration and/or stress can be reduced during operation, and as a result, the service life of the turbine rotor blades 12 can be extended.

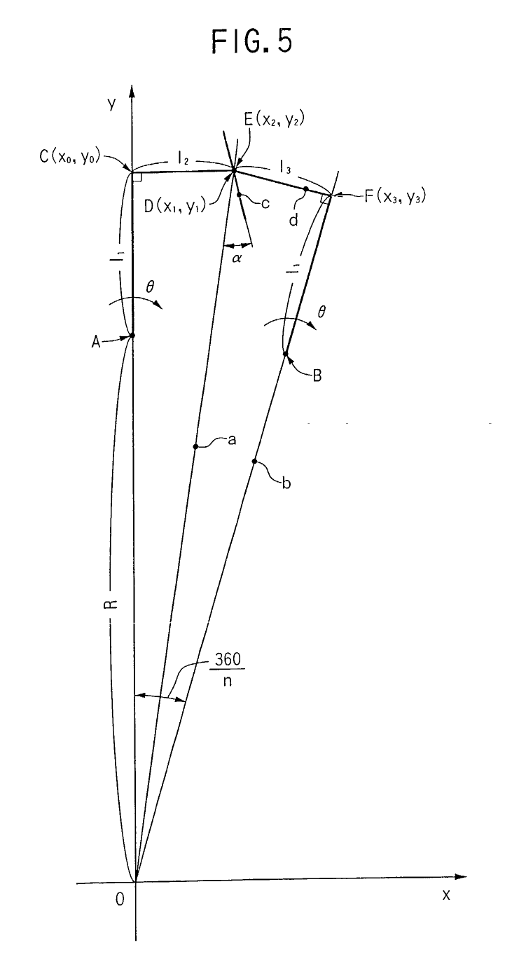

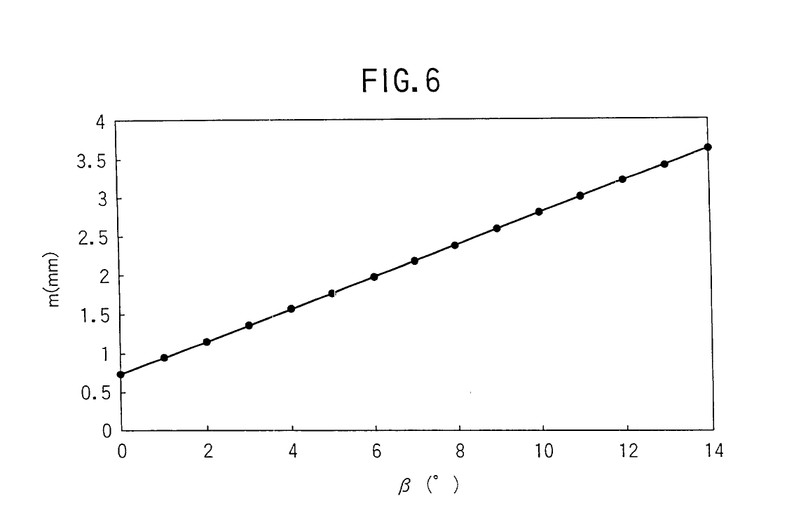

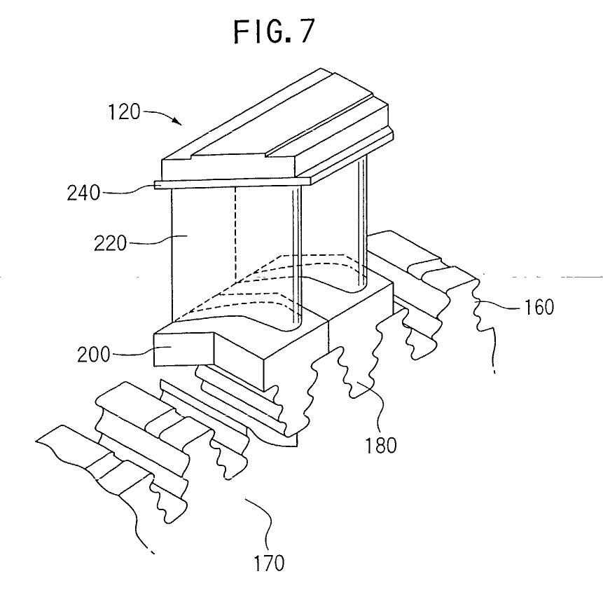

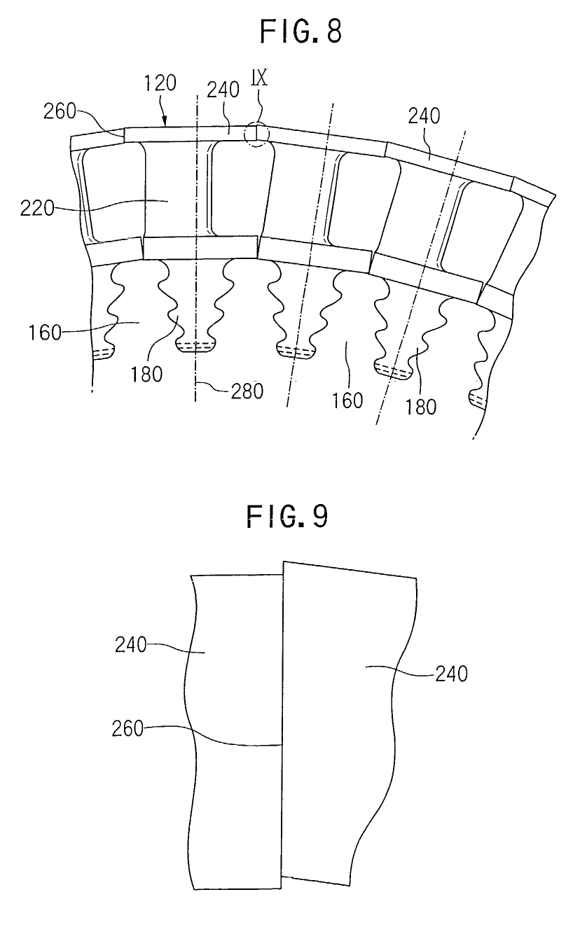

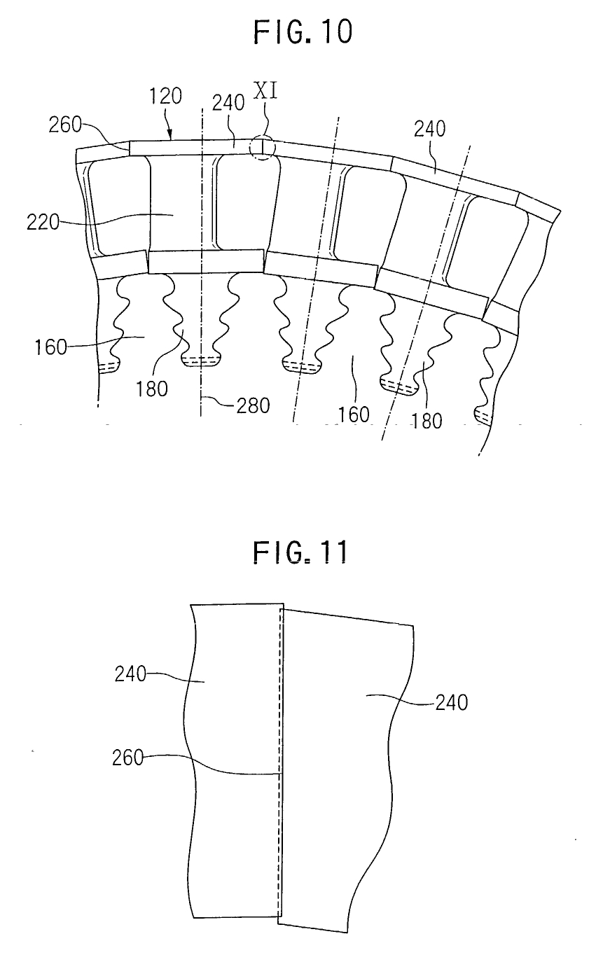

The resultant effect from making slantingly angled abutment engaging surfaces on the top plate of the turbine rotor blades will now be explained below in a somewhat mathematical way. FIG. 5 illustrates a schematic diagram showing a clearance between two adjacent turbine rotor blades for giving a mathematical explanation of variance thereof FIG. 6 illustrates a graphical diagram showing a dimension of clearance versus a slant angle between adjacent turbine rotor blades calculated from FIG. 5.

With reference to FIG. 5, line segment AC corresponds to the length extending from a blade root to a top plate wherein point A is regarded as the center of rotation thereof, while line segment CD corresponds to the length of the top plate. Each of the line segments BF and EF corresponds similarly to the adjacent turbine rotor blade, respectively. Each of the profile members locating upon the straight line extending radially outwardly from the rotation center point O is now rotating, respectively, such that each of the end points D and F of the respective top plates of the turbine rotor blades mates with each other at the same location, and these points located upon the respective end surfaces of the top plates have a slant angle α. When each of the turbine rotor blades are directed at an angle θ at the rotation center thereof, respectively, the orientation of each of the end surfaces of the respective top plates will now be explained below.

Briefly, in a X and Y coordinates plane having coordinate origin point O, assuming that each of the top plates 12 and 13 has the same circumferential length, and also assuming that all of the turbine rotor blades 12 of a number n are disposed in an essentially equally spaced apart relationship circumferentially, straight line “a” extending from the center of the rotor to the end point of the top plate is described as follows:

$$y = \frac{x }{tan ( \frac{360}{2 n} )} \qquad ( 1 )$$

When defining as OA=OB=R and AC=BF=1₁, coordinate positional values of each of the points C, D, E, and F are respectively described as follows:

$$\begin{matrix}C ( {x}_{o} , {y}_{o} ) ; {x}_{o} = 0 \\ {y}_{o} = R + {1}_{1} \\ D ( {x}_{1} , {y}_{1} ) ; {x}_{1} = {x}_{2} = {1}_{2} \\ E ( {x}_{2} , {y}_{2} ) ; {y}_{1} = {y}_{2} = R + {1}_{1} \\ F ( {x}_{3} , {y}_{3} ) ; {x}_{3} = ( R + {1}_{1} ) sin \frac{360}{n} \\ {y}_{3} = ( R + {1}_{1} ) cos \frac{360}{n}\end{matrix}$$

Straight line “b” corresponding to the line segment OF is described as follows:

$$y = \frac{x }{tan ( \frac{360}{n} )} \qquad ( 2 )$$

Where line segment “c” corresponding to the top plate of the turbine rotor blade and line segment “b” cross over each other with an angle α therebetween, β is defined as:

$$β = α - \frac{360}{2 n}$$

Line segment “c” is described as follows:

$$y = - \frac{x}{tan β} + \frac{{x}_{1}}{tan β} + {y}_{1} \qquad ( 3 )$$

The line segment “d” or EF corresponding to the top plate of the adjacent turbine rotor blade is described as follows:

$$y = - ( tan \frac{360}{n} ) x + ( tan \frac{360}{n} ) + {x}_{3} + {y}_{3} \qquad ( 4 )$$

When each of the turbine rotor blades has been rotated by an angle θ, each of the points described above can be indicated with an additional prime ″″′, such that each of the points C′, D′, E′, and F′ are respectively described as follows:

$$\begin{matrix}{C}^{′} ( {x}_{o}^{′} , {y}_{o}^{′} ) ; {x}_{o}^{′} = {1}_{1} sin θ \\ {y}_{o}^{′} = {1}_{1} cos θ + R \\ {D}^{′} ( {x}_{1}^{′} , {y}_{1}^{′} ) ; {x}_{1}^{′} = {1}_{1} sin θ + {1}_{2} cos θ \\ {y}_{1}^{′} = {1}_{1} cos θ - {1}_{2} sin θ + R \\ {E}^{′} ( {x}_{2}^{′} , {y}_{2}^{′} ) ; {x}_{2}^{′} = {R}_{1} sin \frac{360}{n} + {1}_{1} sin ( \frac{360}{n} + θ ) - {1}_{3 } cos ( \frac{360}{n} + θ ) \\ {y}_{2}^{′} = {R}_{1} cos \frac{360}{n} + {1}_{1} cos ( \frac{360}{n} + θ ) - {1}_{3 } sin ( \frac{360}{n} + θ ) \\ {F}^{′} ( {x}_{3}^{′} , {y}_{3}^{′} ) ; {x}_{3}^{′} = {R}_{1} sin \frac{360}{n} + {1}_{1} sin ( \frac{360}{n} + θ ) \\ {y}_{3}^{′} = {R}_{1} cos \frac{360}{n} + {1}_{1} cos ( \frac{360}{n} + θ )\end{matrix}$$

The line “c′” extending through the point (x₁′,y₁′) and having positioned at an angle θ with respect to the line “c” is described as follows:

$$y = - \frac{x}{tan ( β - θ )} + \frac{{x}_{1}^{′}}{tan ( β - θ )} + {y}_{1}^{′} \qquad ( 5 )$$

Similarly, the line ′c″′ extending through the point (x₂′, y₂′) and having positioned at an angle θ with respect to the line “c” is described as follows:

$$y = - \frac{x}{tan ( β - θ )} + \frac{{x}_{2}^{′}}{tan ( β - θ )} + {y}_{2}^{′} \qquad ( 6 )$$

Where a distance m between line “c′” and ′c′″ is as follows:

$${m}^{2} = \frac{\vert {[ {x}_{1}^{′} + tan ( β - θ ) * {y}_{1}^{′} ]}^{2} - {[ {x}_{2}^{′} + tan ( β - θ ) * {y}_{2}^{′} ]}^{2} \vert}{{tan}^{2} ( β - θ ) + 1} \qquad ( 7 )$$

As a result of the equation (7), FIG. 6 illustrate a graphic plot of m versus β for θ=0.5 . As shown in FIG. 6, the distance m between two adjacent end surfaces is generally an increasing function of β, in that, for example, when comparing the value m for β=O with the value m for β=6, the latter is generally twice as much as the former. Accordingly, if a slant angle (α or β) of the end surfaces were selected properly, on one hand, there would occur a certain clearance between two adjacent end surfaces to make assembling easy, by installing turbine rotor blades directed at an angle θ, on the other hand, there would be no such clearance due to the expansion of the pitch dimension caused by a centrifugal force and thermal expansion during operation, so that two adjacent end surfaces of the turbine rotor blades are forced against each other, thereby maintaining a securely fixed circumferential relationship between two adjacent top portions of the turbine rotor blades.

Although the present invention has been described in detail with reference to a specific embodiment, those skilled in the art will recognize that changes may be made thereto without departing from the scope and spirit of the invention as set forth in the appended claims.

Therefore, the turbine rotor blades assembly according to the present invention is provided which can be assembled easily and also can maintain a securely fixed circumferential relationship between two adjacent top portions of the turbine rotor blades during operation.

According to the method for assembling the turbine rotor blades assembly according to the present invention, turbine rotor blades assembly can be assembled easily and also can maintain a securely fixed circumferential relationship between two adjacent top portions of the turbine rotor blades during operation.

What is claimed is:

1. A turbine rotor blades assembly having a plurality of turbine rotor blades fixedly inserted into the outer circumference of a turbine rotor comprising: each of the turbine rotor blades including a profile member extending radially outwardly from a central axis, and a top plate formed integrally with the profile member at the outer end thereof, wherein said top plate provides an abutment interconnection relationship between adjacent turbine rotor blades,
wherein said abutment engaging surfaces between adjacent turbine rotor blades are slantingly angled relative to a mean straight line extending from the center of the rotor to the center of the profile member.

2. A turbine rotor blades assembly as claimed in claim 1, wherein said slant angle is between 5° and 30°.

3. A turbine rotor blades assembly as claimed in claim 1 or 2, wherein said a plurality of turbine rotor blades include a plurality of turbine rotor blades each having a top plate having a circumferential length different from those of the other plates.

4. A method for assembling a turbine rotor blades assembly of claim 1, comprising inserting root portions of turbine rotor blades into corresponding rotor disks one by one until all of the turbine rotor blades are fixedly attached upon the rotor disk, said method comprising the steps of:
inserting a spacer member between a platform of the turbine rotor blade to be attached and an outer surface of the rotor at the side opposite from the previously fixed turbine rotor blade;
biasing the turbine rotor blade to be attached during assembling thereof so as to provide abutment engagement between a top plate of the turbine rotor blade to be attached and a top plate of the turbine rotor blade previously fixed;
repeating said inserting step and biasing step for each of the turbine rotor blades until all of the turbine rotor blades are installed.
